(19) United States
(12) Patent Application Publication
(10) Pub. No.: US 2026/0094963 A1
(43) Pub. Date: Apr. 2, 2026

(54) METASURFACE ANTENNA SATELLITES AND METHODS THEREOF

(71) Applicant: Duke University, Durham, NC (US)

(72) Inventors: Michael Phillip Boyarsky, Durham, NC (US); David Richard Smith, Durham, NC (US); Russell James Hannigan, Port Orchard, WA (US)

(21) Appl. No.: 19/344,061

(22) Filed: Sep. 29, 2025

Related U.S. Application Data
(60) Provisional application No. 63/700,972, filed on Sep. 30, 2024.
(60) Provisional application No. 63/774,404, filed on Mar. 19, 2025.

(51) Int. Cl. H01Q 3/26; G01S 13/90; H01Q 1/28

(52) U.S. Cl. CPC H01Q 3/26; G01S 13/90; H01Q 1/288

(57) ABSTRACT

A satellite antenna tile including an antenna layer oriented facing outward from the tile and configured to emit radio frequency (RF) signals, a structural support layer affixed to the antenna layer and comprising at least one mechanical support structure, and a power supply layer affixed to the structural support layer and comprising one or more power sources disposed on an opposite side of the tile from the antenna layer.

### CROSS-REFERENCE TO RELATED APPLICATIONS

This application claims priority to U.S. Provisional Application No. 63/774,404, filed on Mar. 19, 2025 and titled “HIGH-CAPACITY SPACEBORNE SYNTHETIC APERTURE RADAR SYSTEMS AND METHODS,” and U.S. Provisional Application No. 63/700,972, filed on Sep. 30, 2024 and titled “METASURFACE ANTENNA SATELLITES AND METHODS THEREOF,” the entire contents of each of which are hereby incorporated by reference herein.

### GOVERNMENT INTERESTS

This invention was made with Government support under Federal Grant No. N66001-21C-4016 awarded by the Defense Advanced Research Projects Agency. The Government has certain rights in this invention.

### TECHNICAL FIELD

The present disclosure relates to satellite sensing systems, and in particular, to satellite sensing systems with metasurface antenna tiles and/or passive tuning components for high-capacity spaceborne synthetic aperture radar (SAR) applications.

### BACKGROUND

Metasurface technology has led to the advent of a class of antennas that promises improved hardware characteristics compared to existing microwave sensor technology, including conventional phased arrays and active electronically steered antennas (AESAs). One potential application of this technology is satellite imaging in the form of synthetic aperture radar (SAR). However, conventional satellite SAR systems with electronically reconfigurable antennas face significant power and thermal limitations. Active components in phased arrays introduce inefficiency and require substantial control power, often 100 Ws or more for full scanning capability. Given the limited power budget and thermal management of typical small satellites, these systems can only acquire data for very small periods of time on a given orbit—typically just around 1-2%—with the remaining time spent releasing accumulated heat. To leverage the hardware benefits of metasurface antenna technology and overcome these limitations, there is a need for an improved satellite architecture that integrates metasurface antenna technology within the overall satellite design.

### SUMMARY

In various examples, the subject matter described herein relates to satellite sensing systems with metasurface antenna tiles and/or passive tuning components. According to some embodiments, a satellite antenna tile includes a metasurface antenna layer oriented facing outward from the tile and configured to emit radio frequency (RF) signals. A structural support layer is affixed to the metasurface antenna layer and includes at least one mechanical support structure. A power supply layer is affixed to the structural support layer and includes one or more power sources disposed on an opposite side of the tile from the metasurface antenna layer. In some embodiments, the use of passive tuning components, such as varactor diodes, can significantly reduce the power needed to dynamically reconfigure a spaceborne SAR antenna, enabling high-capacity operation with increased uptime.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a diagram of an example antenna, in accordance with some embodiments.

FIG. 2 is a flow diagram of a method for assembling an antenna tile, in accordance with some embodiments.

FIG. 3 is a diagram of a multi-tile sensing instrument (MTSI), in accordance with some embodiments.

FIG. 4 is a diagram of the MTSI of FIG. 3 in a folded configuration, in accordance with some embodiments.

FIG. 5 is a diagram of an example satellite sensing system, in accordance with some embodiments.

FIG. 6 is a diagram of an example complete satellite system, in accordance with some embodiments.

FIG. 7 is a diagram of an example computing device.

### DETAILED DESCRIPTION

As described above, metasurface antenna technology provides improved hardware characteristics compared to existing microwave sensor technology. For example, metasurface antennas are lightweight, low-cost, planar, and efficient. This combination of characteristics is difficult to realize with other microwave hardware. In particular, the low cost-per-area among electronic beamsteering technologies gives metasurface satellite antennas the unique ability to create large-area apertures in a cost effective manner. Unlike traditional phased array systems that require complex and expensive phase shifters for each element, metasurface antennas can achieve electronic beamsteering through simpler tuning mechanisms, dramatically reducing the per-element cost. This cost reduction becomes exponentially more significant as aperture size increases, making previously prohibitive large-area antenna configurations economically viable for satellite applications.

The manufacturing advantages of metasurface antenna technology also contribute significantly to satellite system benefits. The planar nature of metasurface antennas enables mass production, resulting in higher yield rates and more predictable quality control compared to traditional three-dimensional antenna structures. This manufacturing compatibility reduces production time, lowers defect rates, and enables rapid scaling of satellite production to meet deployment schedules.

Power efficiency represents another critical advantage of metasurface antenna systems in satellite applications. The reduced power consumption of metasurface antennas compared to traditional microwave systems directly translates to smaller power generation requirements, enabling either reduced solar panel area or increased power allocation to other satellite subsystems. This power efficiency is particularly valuable in satellite applications where power generation capacity is fundamentally limited by available surface area and solar panel technology constraints.

The thermal management benefits of metasurface antenna technology provide additional operational advantages. The planar configuration and distributed heat generation characteristics of metasurface antennas facilitate more effective heat dissipation compared to concentrated heat sources in traditional antenna systems. This improved thermal distribution reduces the complexity and mass of thermal management systems, while also improving overall system reliability by avoiding thermal hotspots that can degrade component performance or lifetime (e.g., in a space environment).

The present disclosure describes systems and methods for constructing planar (or flat) satellites through integration with metasurface antennas. When combined with judicious satellite design around these characteristics, the present disclosure outlines an approach to creating antennas of a size that is difficult or infeasible to achieve with existing microwave beamforming technology. In some embodiments, a satellite antenna tile includes a metasurface antenna layer oriented facing outward from the tile and configured to emit radio frequency (RF) signals, a structural support layer affixed to the metasurface antenna layer and comprising at least one structural support feature, and a power supply layer affixed to the structural support layer and comprising one or more power sources disposed on an opposite side of the tile from the metasurface antenna layer. The metasurface antenna layer may incorporate passive tuning components, such as varactor diodes, liquid crystals, or microelectromechanical systems (MEMS), which require minimal control power to operate and can enable dynamic reconfiguration of antenna characteristics while maintaining high system efficiency.

In the context of the disclosure, “metasurface antennas” are generally defined as one-dimensional (1D) or two-dimensional (2D) devices that control and/or manipulate electromagnetic radiation. They use subwavelength elements, which can be sampled densely (e.g., below one-half of the operating wavelength), at the Nyquist criteria (e.g., at or near one-half of the operating wavelength), or coarsely (e.g., above one-half of the wavelength). The radiating elements can follow metamaterial unit cell designs, or they can use other suitable geometries, such as irises and/or slots. These antennas often also include a waveguide feed as part of their architecture, in which one or more waveguides are used to excite the radiators. They can be built as printed circuit boards (PCBs), using liquid crystal construction, using hollow or heterogeneous metal waveguides, and/or some combination of these methods. Other possible methods may be evident to a person of skill in the art. The metasurface antenna layer may be fabricated using various substrate materials including printed circuit board (PCB) substrates such as Rogers RT/duroid, PTFE-based materials, or low-loss ceramic substrates optimized for RF applications. Conductive elements within the metasurface antenna layer are typically formed from copper, gold, silver, or other conductive materials deposited through processes such as photolithography, etching, plating, or additive manufacturing techniques. The substrate thickness and dielectric properties are selected based on operating frequency requirements, bandwidth specifications, and mechanical constraints, with typical substrate thicknesses ranging from 0.1 mm to several millimeters depending on the application. Advanced metasurface implementations may incorporate tunable materials such as liquid crystals, varactor diodes, or phase-change materials that enable dynamic reconfiguration of antenna characteristics during operation.

The term “passive tuning elements,” as used herein generally refers to adjustable components that require minimal control power to operate, such as varactor diodes which are back-biased diodes capable of imparting electronically controlled phase shifts to radiating elements while drawing minimal current.

The term “uptime,” as used herein refers to the portion of time that the satellite system can transmit signals. In some examples, uptime is defined as a percentage of the satellite system's total orbit time (e.g., 5%, 50%, 100%, etc.).

The term “satellite” as used herein generally refers to an orbital spacecraft (e.g., used for collecting and/or relaying information). Satellite architectures can vary substantially and are most often centered around their primary sensors and/or communications devices. The configurations described herein are particularly useful for planar satellites using metasurface antennas. These should be considered non-limiting example embodiments, and other embodiments are within the scope of the present disclosure.

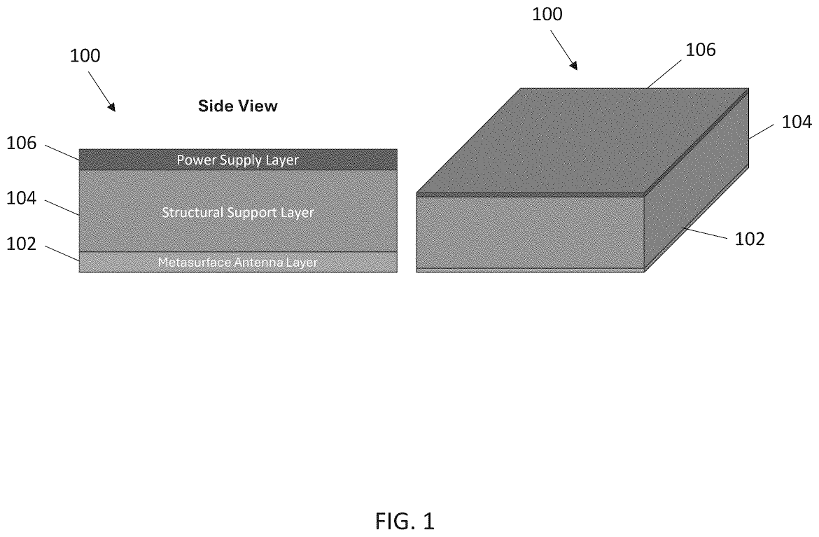

One aspect of the present disclosure provides a satellite antenna module, which can be referred to as a “tile”. FIG. 1 is a schematic illustration of an example antenna tile 100 in accordance with aspects described herein. The antenna tile 100 generally comprises three primary layers or portions: a metasurface antenna layer 102, a structural support layer 104, and a power supply layer 106. Together these layers form a self-contained, independently functioning antenna.

More specifically, the metasurface antenna layer 102 comprises a metasurface antenna, which is the main sensor on this type of satellite. The metasurface antenna is typically oriented facing away or outward from the tile 100. The metasurface antenna layer 102 is used to emit sensing or communication signals (e.g., RF signals) in one or more directions from the satellite (or tile 100).

The structural support layer 104 comprises a mechanical support structure (or feature). This can be, for example, an honeycomb, a truss, a frame, or any other suitable component that provides structural support to the tile. In some examples, the mechanical support structure is fabricated from aluminum or any other suitable material. The structural support layer 104 is affixed directly to the metasurface antenna layer 102. The affixing of the structural support layer 104 to the metasurface antenna layer 102 can be accomplished through various methods including, but not limited to, adhesive bonding, mechanical fastening, welding, brazing, or any combination thereof. The choice of affixing method depends on factors such as thermal expansion compatibility, structural load requirements, and manufacturing constraints. In some embodiments, the affixing method is selected to maintain electrical continuity between the layers while providing adequate mechanical support and thermal management.

The power supply layer 106 comprises one or more power sources. In some examples, the power sources are solar panels. It is noted that, although solar panels are the most common power source, equivalent power sources (e.g., nuclear, fuel cells, radioisotope thermoelectric generators, or battery systems) can be substituted without affecting the operation of the other layers. The power supply layer 106 is disposed on the opposite side of the tile 100 from the metasurface antenna layer 102. The power supply layer 106 is affixed to the structural support layer 104 through various attachment methods, including but not limited to, mechanical fastening systems (such as bolts, screws, or clips), adhesive bonding using space-qualified adhesives, welding techniques for metallic components, or hybrid attachment systems combining multiple methods. The selection of the attachment method depends on factors including thermal cycling requirements in the space environment, mechanical load distribution, electrical isolation requirements, ease of assembly and maintenance. In some examples, the area of the power sources (e.g., solar panels) is substantially the same as the area of the metasurface antenna (or the metasurface antenna layer 102), enabling optimal power generation efficiency while maintaining the compact tile architecture. The power supply layer 106 may also include power conditioning electronics, voltage regulation circuits, and power distribution networks to efficiently manage and distribute electrical power to the metasurface antenna layer 102 and associated control systems.

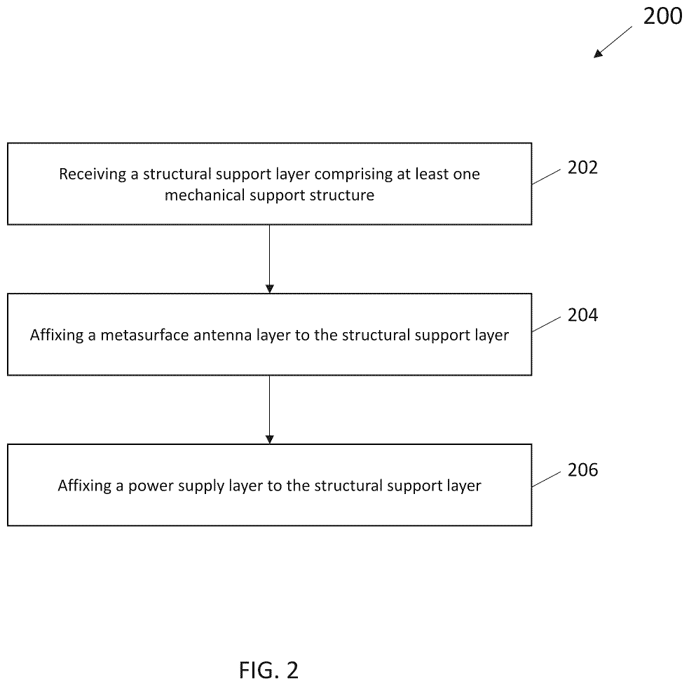

FIG. 2 is a flow diagram of a method 200 for assembling an antenna tile in accordance with aspects described herein. In some examples, the method 200 corresponds to a method for assembling the antenna tile 100 of FIG. 1.

At step 202, a structural support layer is received that includes at least one mechanical support structure. As described above, the structural support layer 104 serves as the foundational component of the antenna tile assembly, providing the necessary mechanical integrity and dimensional stability for the integrated system. The mechanical support structure may comprise various configurations including honeycomb cores, truss frameworks, rigid frames, or hybrid structural assemblies, each selected based on specific mission requirements such as launch loads, thermal cycling, and operational stresses. The structural support layer 104 is typically fabricated from lightweight, high-strength materials such as aluminum alloys, carbon fiber composites, or advanced metallic foams that provide optimal strength-to-weight ratios for space applications. The structural support layer 104 may also incorporate pre-integrated features such as mounting interfaces, cable routing channels, thermal conduction paths, and component mounting provisions that facilitate subsequent assembly operations and system integration.

At step 204, a metasurface antenna layer is affixed to the structural support layer. The metasurface antenna layer 102 comprises the primary sensing component of the antenna tile and is oriented to face outward from the tile to enable optimal signal transmission and reception. The affixing process involves securing the metasurface antenna layer 102 directly to the structural support layer 104 using methods such as adhesive bonding with space-qualified adhesives, mechanical fastening systems including bolts or clips, welding techniques for metallic interfaces, or hybrid attachment approaches combining multiple methods. The selection of the affixing method depends on critical factors including thermal expansion compatibility between materials, structural load distribution requirements during launch and operational phases, electrical continuity requirements for proper antenna function, and manufacturing constraints such as assembly tolerances and process repeatability. Quality assurance procedures during this step may include electrical continuity testing, mechanical bond strength verification, thermal cycling validation, and dimensional accuracy measurements to ensure the assembled antenna tile meets performance specifications. The affixing process must maintain precise alignment between the metasurface antenna layer and structural support layer to preserve antenna beam characteristics and pointing accuracy. Additionally, the attachment method must accommodate differential thermal expansion between the antenna layer 102 and structural components while maintaining electrical and mechanical integrity throughout the satellite's operational temperature range.

At step 206, a power supply layer is affixed to the structural support layer. The power supply layer 106 includes one or more power sources and is positioned on the opposite side of the tile from the metasurface antenna layer 102, creating a sandwich configuration with the structural support layer 104 disposed between the antenna and power components. The affixing process involves securing the power supply layer 106 to the structural support layer 104 using attachment methods including mechanical fastening systems such as bolts, screws, or clips, adhesive bonding using space-qualified adhesives designed for the thermal cycling and vacuum conditions of space, welding techniques for metallic components, or hybrid attachment systems combining multiple methods for enhanced reliability. The power supply layer 106 typically comprises solar panels fabricated from photovoltaic cells mounted on lightweight substrates such as carbon fiber composites, aluminum honeycomb panels, or advanced polymer materials that provide structural support while minimizing mass. The solar panel substrates may incorporate integrated wiring harnesses, bypass diodes for fault tolerance, and protective coverglass materials such as cerium-doped glass or advanced polymer films that provide radiation shielding and micrometeorite protection. The selection of the attachment method depends on factors including thermal cycling requirements in the space environment where temperatures can range from 150° C. to +120° C., mechanical load distribution during launch vibrations and operational stresses, electrical isolation requirements to prevent ground loops and electromagnetic interference, and ease of assembly and maintenance during satellite integration and testing phases. In some embodiments, the area of the power sources substantially matches the area of the metasurface antenna layer 102 to optimize power generation efficiency while maintaining the compact tile architecture that enables modular satellite construction. The power supply layer 106 may also include power conditioning electronics such as maximum power point tracking circuits, voltage regulation modules, current limiting devices, and power distribution networks that efficiently manage and distribute electrical power to the metasurface antenna layer 102 and associated control systems, ensuring stable operation across varying illumination conditions and power demands.

Another aspect of the present disclosure provides a multi-tile sensing instrument (MTSI) comprising a plurality of antenna tiles, where the tiles are assembled to form a larger antenna. In some examples, the tiles are assembled in a planar fashion to form a tiled pattern. In some examples, each tile receives a signal and is individually tuned, resulting in a larger antenna that acts coherently as a single device.

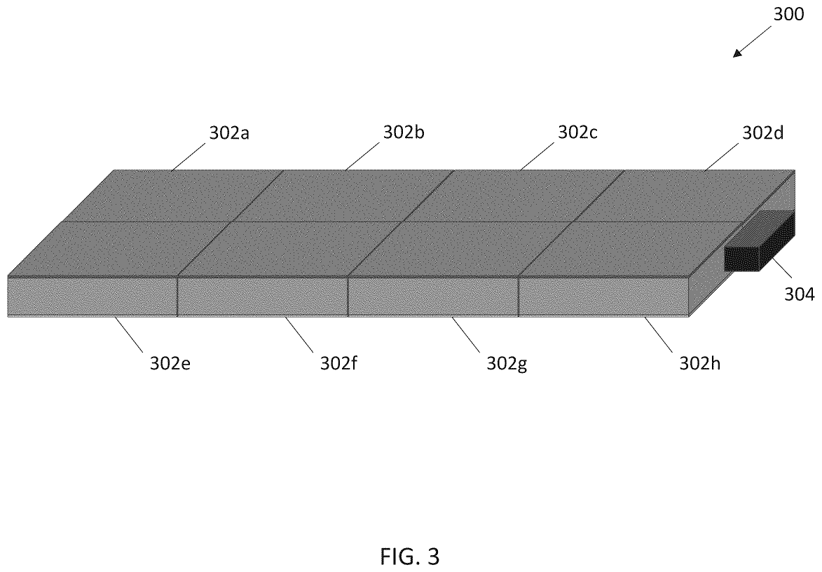

FIG. 3 is a schematic diagram of a MTSI 300 in accordance with aspects described herein. In this example, the MTSI 300 includes a 2×4 array of antenna tiles 302a-302h. In some examples, each antenna tile 302a-302h corresponds to the antenna tile 100 of FIG. 1. The MTSI 300 includes a satellite control module 304. The satellite control module 304 may include additional modules (or sub-modules) such as, for example, a signaling or sensing module and an operation module.

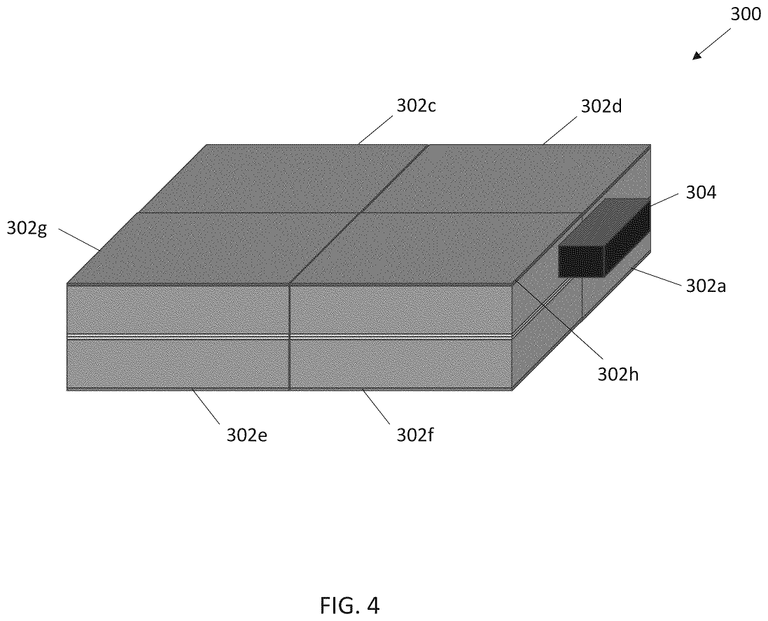

One advantage of the disclosed satellite antenna is that it can be folded one or more times to create a compact launch size. This folding capability is particularly advantageous for large-aperture antenna configurations that would otherwise exceed launch vehicle payload bay constraints. The folding mechanism can be implemented through various hinge systems, including but not limited to, mechanical hinges with locking mechanisms, flexible substrate connections, or deployable structural elements. This is illustrated in FIG. 4, in which the MTSI 300 of FIG. 3 has been folded once to facilitate a more compact launch footprint. As shown, the MTSI 300 has been folded such that tile 302a is beneath tile 302d, tile 302b is beneath tile 302c (not visible), tile 302e is beneath tile 302g, and tile 302f is beneath tile 302h. The folding configuration reduces the overall satellite dimensions during launch while maintaining the structural integrity and electrical connectivity of the antenna tiles. Upon deployment in orbit, the folded sections can be unfolded using deployment mechanisms such as spring-loaded hinges, motor-driven actuators, or shape memory alloy actuators to restore the antenna to its operational configuration. The deployment process can be controlled through the satellite control module 304 to ensure proper sequencing and verification of antenna tile positioning and functionality.

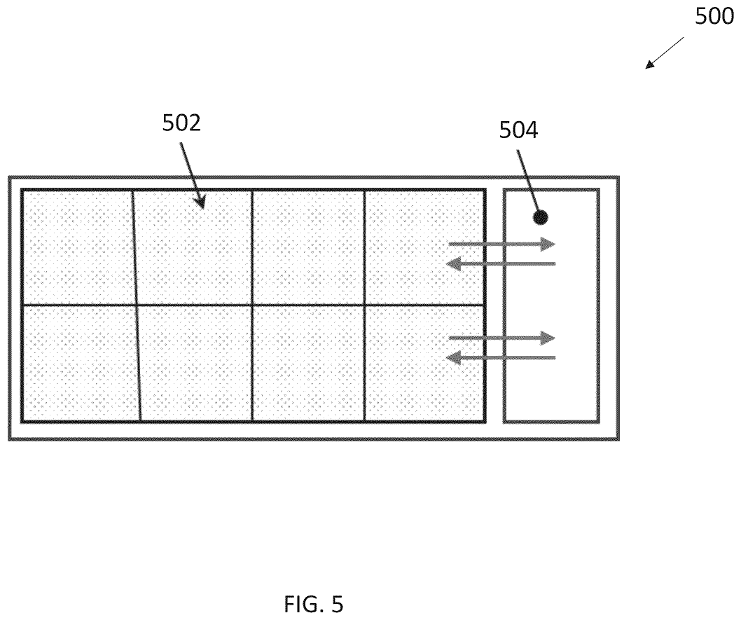

Another aspect of the present disclosure provides a satellite sensing system. The system comprises one or more antenna tiles as described herein (i.e., a single tile and/or an MTSI), along with one or more sensing modules that provide RF signals to the tiles. FIG. 5 illustrates an example satellite sensing system 500 in accordance with aspects described herein. The system 500 includes an array of antenna tiles 502 and a sensing module 504. The sensing module 504 includes the sensors and components necessary for signal generation and reception, which can include but is not limited to amplifiers, isolators, digitizers, data storage and processing, power transmission, power division and/or distribution, mixers, filters, and the like. The sensing module 504 can communicate with the antenna tiles 502 in any suitable fashion (e.g., directly with each tile, pass-through circuits, etc.). The sensing module 504 may be configured to (i) provide RF signals to the antenna tiles 502 for transmission and/or (ii) receive return signals received by the antenna tiles 502. In some examples, one sensing module is used for each independently operating tile or MTSI. Similarly, a satellite sensing system having multiple independent modules or MTSIs may utilize a sensing module for each antenna configuration. The sensing module 504 may be configured with redundant communication pathways to ensure reliable signal transmission in the event of component failure or signal interference. The sensing module 504 may include adaptive signal processing capabilities that automatically adjust transmission parameters based on real-time feedback from the antenna tiles 502, optimizing performance for varying operational conditions such as atmospheric interference target characteristics, or mission requirements. Additionally, the sensing module 504 may incorporate built-in diagnostic systems that continuously monitor the health and performance of both the module itself and the connected antenna tiles 502, enabling predictive maintenance and early detection of potential system degradation

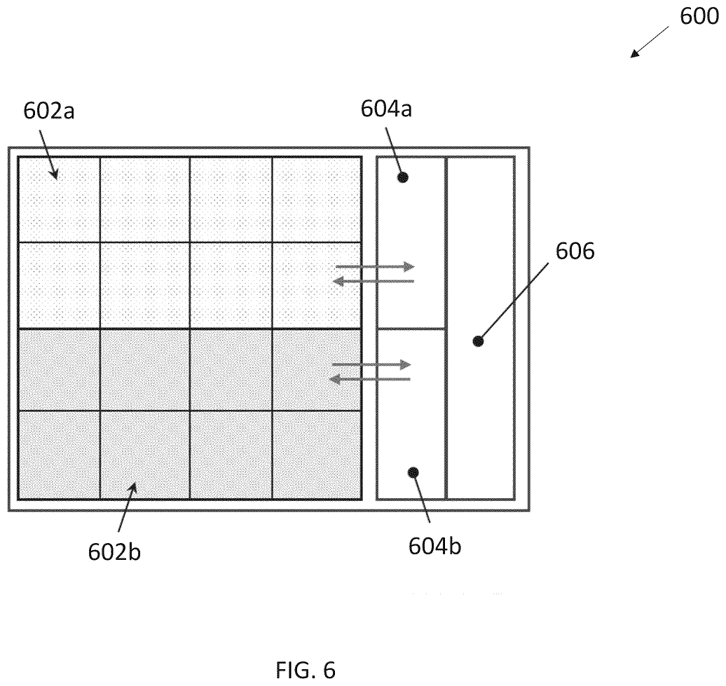

Another aspect of the present disclosure provides a complete satellite system A complete satellite system as disclosed herein comprises one or more antenna tiles (i.e., a single tile and/or a MTSI), one or more sensing modules, and a satellite operation module. FIG. 6 illustrates an example of a complete satellite system 600 in accordance with aspects described herein. The system 600 includes a first MTSI 602a, a second MTSI 602b, a first sensing module 604a, a second sensing module 604b, and a satellite operation module 606.

The satellite operation module 606 includes the components used for the general operation of the satellite, including communication, data downlinks, maneuvering components, and the like. Further, the complete satellite system 600 can include other optional components. These components can reside at any suitable location, such as within cavities in the structural layer of the tiles, on or within the tiles as an additional layer, and/or within the sensing or operation modules, depending on the size and function of each component. Some examples of satellite system components include, but are not limited to: antenna control components for tuning individual radiating elements within each metasurface antenna layer, signal generation and reception components including RF amplifiers and digitizers, power storage and distribution components such as batteries and power conditioning electronics, thermal management components including radiative panels and heat transfer systems integrated within the structural support layers, and data management components for computation, processing, storage, and communication functions. These components may be distributed throughout the satellite system 600, integrated within individual antenna tiles, or centralized within dedicated modules depending on system requirements and operational constraints.

Antenna control components are the dedicated control components used to tune each radiating element on a module (or tile). These control components enable dynamic beamforming and beam steering capabilities by adjusting the phase, amplitude, and/or frequency response of individual elements within the metasurface antenna layer 102. The control components or electronics can be located behind or within each tile, providing distributed control architecture, or with a main control computer located in the satellite control module 606 on one side of the satellite system 600, enabling centralized control coordination. The control system may implement real-time feedback mechanisms to optimize antenna performance based on operational conditions, target characteristics, and mission requirements. Control signals may be transmitted through dedicated control buses, multiplexed with power distribution lines, or via wireless communication links between the control electronics and individual radiating elements.

Signal generation and reception components include the RF, or microwave, components used to send and/or receive signals can be disposed directly behind or within a tile. This may include components such as local oscillators for frequency synthesis, power amplifiers for signal transmission, low-noise amplifiers for signal reception, digitizers for analog-to-digital conversion, isolators for preventing signal reflection, signal generators for waveform creation, modulators for signal encoding, mixers for frequency conversion, filters for signal conditioning, phase-locked loops for frequency stabilization, and the like. These components may be implemented using various technologies including solid-state electronics, integrated circuits, or hybrid assemblies depending on frequency requirements, power levels, and environmental constraints. The RF components may be configured in transmit-only, receive-only, or transmit/receive configurations to support different operational modes and mission requirements.

Batteries(or equivalent power storage and distribution components) may be used to store power for later use, including eclipse operation, and can be distributed throughout the satellite. These power storage systems may include rechargeable battery technologies such as lithium-ion, nickel-hydrogen, or advanced battery chemistries optimized for space environments. Power transfer components can be included as well, such as power conditioning units, voltage regulators, current limiters, and power distribution networks that manage electrical power flow between the power supply layer, antenna control systems, and RF components. The power management system may implement load balancing algorithms to optimize power distribution among multiple antenna tiles, prioritize critical functions during power-limited conditions, and provide fault isolation to prevent system-wide power failures. It is noted that the power and signaling components can be centrally located, distributed between tiles, or a combination thereof, allowing flexible system architectures that can be optimized for specific mission requirements and operational constraints.

Heat management components include radiative panels for heat rejection that may be included along the perimeter of the satellite or at other suitable locations. These thermal management systems may incorporate passive heat rejection devices such as radiative fins, heat pipes, thermal straps, and phase-change materials, as well as active thermal control systems including thermoelectric coolers, fluid loops, and temperature-controlled heaters. Other heat transfer and/or heat rejection components can be included within the structural support layers 104 of the antenna tiles, or between the metasurface antenna layers 102 and structural support layers 104. Thermal interface materials may be used to enhance heat conduction between components and layers, while thermal isolation materials may be strategically placed to prevent unwanted heat transfer. In configurations where the metasurface antenna is built from metal waveguides or metal-backed PCBs, the metasurface antenna layer 102 can be affixed to thermal management components and contribute directly to heat management by serving as a heat spreading surface or thermal conduction path. The thermal management system may include temperature monitoring sensors and adaptive thermal control algorithms to maintain optimal operating temperatures across varying orbital conditions and power dissipation levels.

Data management components include other components for computation, data processing, data storage, avionics, positioning, intersatellite communications, tasking, downlink, and other actions can be included. These computer-based components may include high-performance processors for real-time signal processing, field-programmable gate arrays (FPGAs) for adaptive algorithm implementation, memory systems for data buffering and storage, solid-state drives for long-term data retention, and network interfaces for data communication. The data management system may implement data compression algorithms to optimize storage efficiency and downlink bandwidth utilization, error correction coding to ensure data integrity in the space environment, and encryption capabilities to secure sensitive information. Processing capabilities may include synthetic aperture radar (SAR) image formation algorithms, target detection and classification functions, and mission planning software. These computer-based components can be contained, for example, within a module on one side of the satellite or incorporated in modular antenna tiles, enabling distributed processing architectures that can provide redundancy, load balancing, and fault tolerance. The data management system may also include autonomous decision-making capabilities for adaptive mission execution and real-time response to changing operational conditions.

Another aspect of the present disclosure provides a method of forming a satellite antenna using a plurality of antenna modules as disclosed herein. As described above, the antenna modules may be assembled in a tile pattern (e.g., 1×2, 1×4, 2×4, 4×4, etc.). Though the individual tiles exhibit unique tuning states when compared to other tiles, they are optimized in context of the satellite antenna to coherently form one radiation pattern as a coherent device. The radiation pattern will most often be a single directive, steerable beam, though other patterns can also be generated (e.g., multi-lobe beams).

A satellite system as disclosed herein has several advantages over conventional satellite systems. For example, the system can be constructed to include multiple antennas with different aspect ratios and differing configurations operating on the same system. This allows highly flexible configurations. For example, it is possible to split the transmitting and receiving signals into different antenna subsets. The design can be configured as dual and/or quad (aka “single-shot”) polarized systems. It can further provide differing beam patterns from differently shaped antennas, thus allowing customized imaging modes and coverage options. In some examples, each antenna subset includes a grid of antenna tiles 100 (e.g., a 1×6 grid, a 4×4 grid, etc.). For example, an antenna configuration may include a first antenna subset paired with a second antenna subset. The first antenna subset is configured to transmit signals with V polarization and the second antenna subset is configured to receive signals with V polarization. Likewise, the configuration may include a third antenna subset paired with a fourth antenna subset. The third antenna subset is configured to transmit signals with H polarization and the fourth antenna subset is configured to receive signals with H polarization. A fifth antenna subset is configured to transmit and receive signals with V polarization. In some examples, the subsets are configured for different beamwidths. For example, the first and second subsets are configured for long, narrow beams/swaths and the third, fourth, and fifth subsets are configured for wider beams.

The flexible configuration capabilities may extend beyond polarization diversity to include frequency diversity, where different antenna subsets can operate at different frequency bands simultaneously, enabling multi-band sensing or communication capabilities. Temporal diversity can also be implemented, where antenna subsets alternate between transmit and receive functions in coordinated time sequences to optimize power management and thermal loading. The system architecture can support dynamic reconfiguration of antenna subset assignments during operation, allowing mission planners to adapt the satellite's sensing capabilities to changing requirements or operational conditions. Advanced interference mitigation techniques can be implemented by configuring certain antenna subsets as dedicated interference cancellation arrays, using adaptive nulling algorithms to suppress unwanted signals while maintaining sensitivity to desired targets. The modular nature of the antenna tile architecture enables graceful degradation, where individual tiles or subsets can be disabled due to component failures while maintaining overall system functionality through reconfiguration of the remaining operational tiles.

Another aspect of the present disclosure provides high-capacity spaceborne SAR systems that utilize passive tuning elements to achieve significantly increased uptime compared to conventional systems. As used herein, a high-capacity spaceborne SAR system refers to a satellite system with a reconfigurable antenna that can operate with high duty cycle and requires minimal power to operate and reconfigure the antenna. A satellite-based SAR system consists of a RF source, a static or dynamically reconfigurable antenna, the satellite bus, and other control and processing hardware that together are used to acquire data and form images of targets. While systems with static antennas can perform imaging functions and have been used over the years, such systems are not easily redirected to access different target areas, since the entire satellite assembly must be rotated. The rotation of the satellite during orbit is a relatively slow process, limiting the image capacity of the system. Requiring rotation also creates challenges with priority, since the system cannot rapidly retarget disparate areas during the limited transit time while the satellite passes overhead. Further, advanced imaging methods that provide flexibility on scene size and resolution, such as scanning modes, are not possible with static antenna systems.

For rapid retargeting of the system, electronically reconfigurable antennas are desirable. Such antennas are typically variants of phased arrays, consisting of arrays of radiating elements, each with a phase shifter, possibly one or more amplifiers, and associated drive and control electronics. As described above, metasurface antennas provide an alternative approach that can achieve electronic beamsteering through simpler tuning mechanisms. However, the presence of active devices, such as phase shifters and amplifiers, in conventional phased array antennas and active electronically steered antennas (AESAs) requires additional power just for controlling the antenna's transmit and/or receive pattern.

The active components in a phased array introduce inefficiency both directly and by nature of needing additional control power. Since the power collection and storage systems on satellites are not perfectly efficient, requiring more power further decreases the overall system efficiency and creates additional waste heat. Operating in near-vacuum conditions makes system efficiency important for performance because all waste heat generated from inefficiency is difficult to release.

For full scanning (horizon-to-horizon), a set of these active elements must be placed at every radiating node in a Nyquist-sampled array, leading to substantial power consumption of 100 Ws or more. Hybrid and/or sparse phased arrays, in which a limited number of phase shifters are used at the expense of the angular tuning range, still draw considerable power.

Given the limited power budget and thermal management of a typical small satellite, the additional power draw and associated thermal load of the reconfigurable antenna impose a critical limitation on the image-gathering capability of a satellite SAR system. Existing systems that make use of such antennas can only acquire data for a very small period of time on a given orbit-typically just around 1-2%-with the remaining time spent releasing the accumulated heat away from the satellite. This limitation is not present on systems with static antennas, which can acquire data for larger percentages of each orbit.

The image capacity of satellite-based SAR systems can be greatly increased by replacing the phase shifters and amplifiers used by conventional phased arrays and AESAs with passive tuning elements, such as varactors. As used herein, passive tuning elements refer to adjustable components that require minimal control power to operate. Varactors are capable of imparting electronically controlled phase shifts to radiating elements, but draw minimal current since they are back-biased diodes. The reduced power and thermal load translates directly to a larger image capacity for satellite SAR systems with dynamically reconfigurable antennas, enabling the metasurface antenna tiles described herein to operate with significantly higher efficiency.

Using varactor diodes, or other passive tuning components, to reduce the power needed to dynamically reconfigure a spaceborne SAR antenna can be achieved in several ways. First, as described above in the context of the satellite antenna tiles, metasurface antennas have demonstrated the ability to create electronic steering with passive components by tuning resonant radiators. Although the range of the available phase shift in varactor-loaded resonators is limited to 180 degrees, rather than the 360 degrees of active phase shifters, such systems can achieve similar performance levels as phased arrays and AESAs through careful design. Second, low-power phased array architectures can be envisioned in which the tuning is accomplished either by modulating each radiating element to impart a phase shift or by adjusting the phase of RF signals before reaching the radiating elements. Further strategies and architectures are also possible in which varactor diodes (or other passive components) are able to unlock a system with reduced beamforming fidelity and/or system complexity in exchange for reduced power demands.

High-capacity spaceborne SAR systems utilizing the satellite antenna tiles and sensing systems described herein can enable the creation of new capabilities and systems that would be impractical when substantial control power is required. One such system is a passive, reconfigurable, receive-only satellite SAR system. In such a system, avoiding high-power transmission eliminates the need for high-power amplification systems that are often on the order of kilowatts. Since passive tuning components avoid the need for significant control power, the overall system has minimal power required for operation and generates minimal waste heat, leading to the ability to collect measurements continuously. This type of system could be used to collect bistatic measurements (reflections from another friendly system's transmissions). Additionally, this type of system could collect passive radar measurements, in which other sources of RF transmission are used as “sources of opportunity,” such as communications satellites, weather radars, radio stations, or other imaging satellites. In these cases, using passive tuning components is key to enabling a low-power system that can operate continuously.

By utilizing passive tuning components in the metasurface antenna tiles described herein, the satellite sensing systems can achieve uptime percentages of 5%, 10%, 25%, 50%, or even 100% of each orbit, compared to the typical 1-2% uptime of conventional systems with active phase shifters. This increased capacity enables new operational modes including continuous passive radar measurements using sources of opportunity such as communication satellites, weather radars, radio stations, or other imaging satellites. The modular antenna tile architecture facilitates these enhanced capabilities while maintaining the power efficiency benefits of passive tuning elements.

The satellite sensing systems incorporating the metasurface antenna tiles described herein can operate in various modes including stripmap imaging, spotlight/steering modes, scanning modes, and hybrid/extended area modes. The systems can be configured for transmit-only, receive-only, or transceiver operation, and can collect bistatic measurements from other satellite transmissions or passive radar measurements from sources of opportunity. The reduced power requirements of passive tuning components enable these diverse operational capabilities while maintaining system efficiency, making the modular antenna tile architecture particularly well-suited for high-capacity spaceborne SAR applications. While the above examples and embodiments describe metasurface antennas, it should be appreciated that similar systems, structures, devices, etc. may be contemplated using different types and configurations of antennas. For example, the antenna layer 102 could alternatively comprise phased array antennas with electronically steerable elements, patch antenna arrays with individual radiating elements arranged in regular patterns, horn antennas configured for directional transmission and reception, reflector antennas including parabolic or shaped reflector configurations, slot antennas with apertures cut into conductive surfaces, dipole antenna arrays with multiple radiating elements, helical antennas for circular polarization applications, hybrid antenna configurations combining multiple antenna technologies, or any other suitable antenna technology. Each of these alternative antenna types could be integrated into the layered tile architecture described herein (e.g., as shown in FIG. 1), with the antenna layer oriented facing outward from the tile and configured to emit RF signals (or other signals), while maintaining the structural support layer and power supply layer configuration. The selection of antenna type may depend on specific mission requirements including frequency band, beamwidth, polarization, power handling capability, and environmental constraints, with the modular tile architecture providing flexibility to accommodate various antenna technologies within the same satellite system framework.

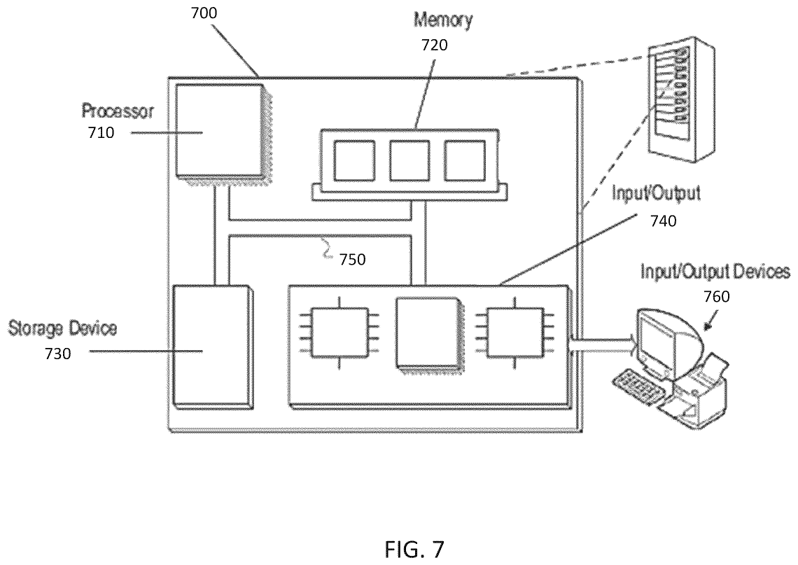

FIG. 7 is a block diagram of an example computer system 700 that may be used in implementing the systems and methods described herein. For example, one or more computer systems, such as the computer system 700, may be operable to perform the operations of the engines and models described herein. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730.

The memory 720 stores information within the system 700. In some implementations, the memory 720 is a non-transitory computer-readable medium. In some implementations, the memory 720 is a volatile memory unit. In some implementations, the memory 720 is a non-volatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 730 is capable of providing mass storage for the system 700. In some implementations, the storage device 730 is a non-transitory computer-readable medium. In various different implementations, the storage device 730 may include, for example, a hard disk device, an optical disk device, a solid-date drive, a flash drive, or some other large capacity storage device. For example, the storage device may store long-term data (e.g., database data, file system data, etc.). The input/output device 740 provides input/output operations for the system 700. In some implementations, the input/output device 740 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 730 may be implemented in a distributed way over a network, such as a server farm or a set of widely distributed servers, or may be implemented in a single computing device.

Although an example processing system has been described in FIG. 7, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

### Some Embodiments

Some embodiments may include any of the following:

A1. A satellite antenna tile including a metasurface antenna layer, a structural support layer, and a power supply layer.

A2. The satellite antenna tile of clause A1, wherein structural support layer is disposed between the metasurface antenna layer and the power supply layer.

A3. A multi-tile sensing instrument including a plurality of antenna tiles, wherein the antenna tiles operate coherently as a single device.

A4. A satellite sensing system including one or more antenna tiles and at least one sensing module.

A5. A complete satellite system including one or more antenna tiles, one or more sensing modules, and a satellite operation module.

A6. The complete satellite system of clause A5, further including antenna control components, signal generation and reception components, power storage components, heat management components, and/or data management components.

A7. A method of forming a satellite antenna including assembling a plurality of antenna modules such that the antenna modules operate coherently as a single device.

A8. A satellite antenna tile including an antenna layer oriented facing outward from the tile and configured to emit radio frequency (RF) signals; a structural support layer affixed to the antenna layer and comprising at least one mechanical support structure; and a power supply layer affixed to the structural support layer and comprising one or more power sources disposed on an opposite side of the tile from the antenna layer.

A9. The satellite antenna tile of clause A8 can include any of the following components or features, in any combination. The antenna layer is a metasurface antenna layer. The at least one mechanical support structure is disposed between the antenna layer and the power supply layer. The at least one mechanical support structure comprises a honeycomb, a truss, or a frame. The at least one mechanical support structure is fabricated from aluminum. The one or more power sources comprise one or more solar panels. An area of the one or more solar panels is substantially the same as an area of the antenna layer. The antenna layer comprises at least one passive tuning element. The at least one passive tuning element is one of a varactor diode, liquid crystal, or microelectromechanical system (MEMS).

A10. A satellite sensing system including a plurality of antenna tiles according to clause A8; and at least one sensing module.

A11. The satellite sensing system of clause A8 can include any of the following components or features, in any combination. The at least one sensing module is configured to provide RF signals to the plurality of antenna tiles for emission. Each antenna tile of the plurality of antenna tiles has a corresponding sensing module. The at least one sensing module is configured to (i) provide the RF signals to the plurality of antenna tiles and/or (ii) receive return signals received by the plurality of antenna tiles via a direct connection with each antenna tile of the plurality of antenna tiles. A first antenna tile of the plurality of antenna tiles comprises a pass-through circuit to direct at least a portion of an RF signal received at the first antenna tile to a second antenna tile of the plurality of antenna tiles. The plurality of antenna tiles are configured to emit the RF signals and receive return signals corresponding to the emitted RF signals. A first portion of the plurality of antenna tiles are configured to emit the RF signals and a second portion of the plurality of antenna tiles are configured to receive return signals corresponding to the emitted RF signals. A first sensing module is configured to provide first RF signals to a first portion of the plurality of antenna tiles and a second sensing module is configured to provide second RF signals to a second portion of the plurality of antenna tiles. The first portion of the plurality of antenna tiles are configured to emit the first RF signals with a first polarization and the second portion of the plurality of antenna tiles are configured to emit the second RF signals with a second polarization, the second polarization being different than the first polarization. The satellite system is configured to be operated with an uptime between 10-100% of a total orbit time

A12. A method of assembling a satellite antenna tile including receiving a structural support layer comprising at least one mechanical support structure; affixing an antenna layer configured to emit radio frequency (RF) signals to the structural support layer, the antenna layer being oriented to face outward from the tile; and affixing a power supply layer to the structural support layer, the power supply layer comprising one or more power sources disposed on an opposite side of the tile from the antenna layer.

A13. The satellite sensing system of clause A12 can include any of the following components or features, in any combination. The antenna layer is a metasurface antenna layer. The at least one mechanical support structure comprises a honeycomb, a truss, or a frame. The at least one mechanical support structure is fabricated from aluminum.

A14. A satellite-based, radio-frequency (RF) sensing system including a satellite bus; a power source (such as a solar array and/or battery); an RF source; an RF receive circuit; a signal processing system; a control system for the antenna (including power, antenna control computer, and digital circuitry); all other processing and communications hardware and software; and an antenna whose radiation is reconfigured with a set of passive tuning elements.

A15. The system of clause A14 can include any of the following components or features, in any combination. The passive tuning components are varactor diodes. The passive tuning components are liquid crystals. The passive tuning components are microelectromechanical systems (MEMS). The antenna, satellite bus, and support components have been collectively optimized for power and thermal efficiency and the system can spend 5% of each orbit acquiring data. The system can achieve uptime of 10%, 25%, 50%, or 100% of each orbit. The antenna elements are resonant radiators (such as metamaterial elements or Complimentary Electric-LCs (CELCs)). The antenna elements are rectangular patches. The passive tuning components modulate RF signals before reaching radiating elements. The system uses a stripmap imaging mode. The system uses a spotlight/steering mode. The system uses scanning modes. The system uses hybrid/extended area modes. The system takes RF measurements that are directly processed with postprocessing algorithms. The system only uses the RF source and the satellite operates only as a transmitter. The system only uses the RF receiver and the satellite operates only as a receiver. The system includes an RF transceiver. The system transmits and/or receives signals to/from other satellites. The system collects reflections from “sources of opportunity,” such as communication satellites, weather radars, radio stations, or other non-SAR satellite transmitters. The system is capable of operating continuously (i.e., with 100% uptime).

While this specification contains many specific implementation details, these should not be construed as limitations on the scope, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes.

The phraseology and terminology used herein is for the purpose of description and should not be regarded as limiting.

The indefinite articles “a” and “an,” as used in the specification, unless clearly indicated to the contrary, should be understood to mean “at least one. ” The phrase “and/or,” as used in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. In general, the term “or” as used shall only be interpreted as indicating exclusive alternatives (i.e. “one or the other but not both”) when preceded by terms of exclusivity, such as “either,” “one of,” “only one of,” or “exactly one of.”

As used in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Articles “a” and “an” are used herein to refer to one or to more than one (i.e., at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered expressly stated in this disclosure.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope.

What is claimed is:

1. A satellite antenna tile, comprising:
an antenna layer oriented facing outward from the tile and configured to emit radio frequency (RF) signals;
a structural support layer affixed to the antenna layer and comprising at least one mechanical support structure; and
a power supply layer affixed to the structural support layer and comprising one or more power sources disposed on an opposite side of the tile from the antenna layer.

2. The antenna tile of claim 1, wherein the antenna layer is a metasurface antenna layer.

3. The antenna tile of claim 1, wherein the structural support layer is disposed between the antenna layer and the power supply layer.

4. The satellite antenna tile of claim 1, wherein the at least one mechanical support structure comprises a honeycomb, a truss, or a frame.

5. The satellite antenna tile of claim 1, wherein the at least one mechanical support structure is fabricated from aluminum.

6. The satellite antenna tile of claim 1, wherein the one or more power sources comprise one or more solar panels.

7. The satellite antenna tile of claim 6, wherein an area of the one or more solar panels is substantially the same as an area of the antenna layer.

8. The satellite antenna tile of claim 1, wherein the antenna layer comprises at least one passive tuning element.

9. The satellite antenna tile of claim 8, wherein the at least one passive tuning element is one of a varactor diode, liquid crystal, or microelectromechanical system (MEMS).

10. A satellite sensing system, comprising:
a plurality of antenna tiles according to claim 1; and
at least one sensing module.

11. The satellite system of claim 10, wherein the at least one sensing module is configured to provide RF signals to the plurality of antenna tiles for emission.

12. The satellite system of claim 11, wherein each antenna tile of the plurality of antenna tiles has a corresponding sensing module.

13. The satellite system of claim 11, wherein the at least one sensing module is configured to (i) provide the RF signals to the plurality of antenna tiles and/or (ii) receive return RF signals received by the plurality of antenna tiles via a direct connection with each antenna tile of the plurality of antenna tiles.

14. The satellite system of claim 11, wherein a first antenna tile of the plurality of antenna tiles comprises a pass-through circuit to direct at least a portion of an RF signal received at the first antenna tile to a second antenna tile of the plurality of antenna tiles.

15. The satellite system of claim 11, wherein the plurality of antenna tiles are configured to emit the RF signals and receive return signals corresponding to the emitted RF signals.

16. The satellite system of claim 11, wherein a first portion of the plurality of antenna tiles are configured to emit the RF signals and a second portion of the plurality of antenna tiles are configured to receive return signals corresponding to the emitted RF signals.

17. The satellite system of claim 11, wherein a first sensing module is configured to provide first RF signals to a first portion of the plurality of antenna tiles and a second sensing module is configured to provide second RF signals to a second portion of the plurality of antenna tiles.

18. The satellite system of claim 17, wherein the first portion of the plurality of antenna tiles are configured to emit the first RF signals with a first polarization and the second portion of the plurality of antenna tiles are configured to emit the second RF signals with a second polarization, the second polarization being different than the first polarization.

19. The satellite system of claim 10, wherein the satellite system is configured to be operated with an uptime between 10-100% of a total orbit time.

20. A method of assembling a satellite antenna tile, comprising:
receiving a structural support layer comprising at least one mechanical support structure;
affixing an antenna layer configured to emit radio frequency (RF) signals to the structural support layer, the antenna layer being oriented to face outward from the tile; and
affixing a power supply layer to the structural support layer, the power supply layer comprising one or more power sources disposed on an opposite side of the tile from the antenna layer.
